(19) United States
(12) Patent Application Publication
(10) Pub. No.: US 2003/0079005 A1
(43) Pub. Date: Apr. 24, 2003

(54) System and method for efficient wide area network routing

(75) Inventors: Andrew C. Myers, Pittsburgh, PA (US); Paul W. Placeway, Pittsburgh, PA (US); David A. Rochberg, Pittsburgh, PA (US)

Correspondence Address: Richard W. James, Morgan, Lewis & Bockius LLP, 1701 Market Street, Philadelphia, PA, 19103-2921, US

(73) Assignee: 61C Networks, Inc.

(21) Appl. No.: 09/866,932

(22) Filed: May 29, 2001

(51) Int. Cl. G06F 15/16; G06F 15/173

(52) U.S. Cl. 709/223; 709/203

(57) ABSTRACT

An overlay on a wide area network is disclosed. The wide area network includes at least one backbone network, and the overlay includes a processor coupled to the backbone network. The processor furthermore contains instructions which, when executed, cause the processor to optimize real time performance of data delivery from the processor to another processor on the wide area network. A method of optimizing at least two routes in a wide area network is also provided. The method includes optimizing a first route based on a first characteristic and optimizing a second route based on a second characteristic.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention is related to efficient routing of packets on a wide area network and, more particularly, to a server network architecture overlaid on the wide area network and the use of a local area network style protocol in connection with the server network to automatically configure the server network to achieve efficient routing and caching.

2. Description of the Background

The Internet is a network of computers, dumb terminals, or other, typically processor-based, devices interconnected by one or more forms of communication media. Typical interconnected devices range from handheld computers and notebook PCs to high-end mainframe and supercomputers. The communication media coupling those devices include twisted pair, co-axial cable, optical fibers and radio frequencies. Each coupled device is equipped with software and hardware that enables it to communicate using the same procedures or languages. The implementation of those procedures and languages is generally referred to as a protocol. Protocols are, furthermore, often layered over one another to form something called a “protocol stack.”

One such protocol stack includes Transmission Control Protocol (TCP) and Internet Protocol (IP). An end user device connected to the Internet, such as a personal computer typically includes a program, such as a browser, that communicates between data from applications operating on the personal computer and the TCP/IP protocol stack. TCP packages data into packets that typically include the address of the node from which the packet originates, the size of the packet where applicable, and the address of the destination node to which the packet is to be delivered. Because data is usually sent in multiple packets, the packets also typically include a label indicating the order in which they are to be assembled once they arrive at their destination. After the packets are created, the IP layer transmits the packets across a network such as the Internet.

World Wide Web communication involves another protocol referred to as the Hypertext Transfer Protocol (HTTP) that permits the transfer of Hypertext Markup Language (HTML) documents between computers. The HTML documents are often referred to as “web pages” and are files containing information in the form of text, videos, images, links to other web pages, and so forth. Each web page is stored in an interconnected processor based device that is typically referred to as an “Internet Server,” and has a unique address referred to as a Universal Resource Locator (URL). The URL is used by a program referred to as a “web browser” located on one interconnected computer to find a web page stored somewhere on another computer connected to the network. That creates a “web” of computers each storing a number of web pages that can be accessed and transferred using a standard protocol, and hence this web of computers is referred to as the World Wide Web.

The Internet may be viewed as a wide area network that interconnects many Local area networks. At the highest level, the Internet is made up of Network Access Points (“NAPs”) interconnected to one another by many alternate routes and interconnected to lower level Metropolitan Area Exchanges (“MAEs”) at speeds of 45 to 622 Mbps. The Metropolitan Area Exchanges are, in-turn, interconnected to Internet Service Providers (“ISP's”) at speeds of up to 45 Mbps. Internet users, such as businesses and personal users are then interconnected to ISP's through various media including dedicated lines leased from telephone companies, switched telephone lines, coaxial cable access leased from cable television companies, and through wireless connections.

The Internet consists of thousands of networks and hundreds of thousands of interconnections between those networks. Just like a system of roads and highways, there are many different paths by which to get from one point to another. Those many paths are the source of the Internet's resilience and robustness because if one path becomes unavailable there are many other paths to take its place, allowing data to reach its destination even while one or more interconnection on the network is broken.

Border Gateway Protocol (BGP), the routing protocol that the Internet uses, is not designed to exploit alternate paths to improve performance. BGP has three main goals: basic connectivity, extreme stability, and massive scalability. Each router on the Internet that participates in the BGP protocol only advertises a single route to each possible destination. In other words, BGP explicitly discards information about alternate routes. While this might decrease the quality of the network's routing, it does help to achieve the goals of scalability by decreasing the amount of data exchanged between routers.

Further, BGP takes a very simple, coarse-grained view of the network. The BGP protocol views a path in a network as either “up,” meaning that path is operating and data may be passed on that path or “down,” meaning that the path is not operating and data may not be passed on that path. BGP does not consider, for example, the bandwidth or latency of the path. Further, BGP sees a path as a series of hops, where each hop is another network. For instance, where two network providers 32 and 34, such as UUnet and MCI, are connected to each other as shown in FIG. 1, and a first node 36 coupled to the first network 32 is communicating with a second node 38 coupled to the second network 34 utilizing BGP, the first node 36 is considered to be one hop away from second node 38. There may, however, be two interconnections 40 and 42 (also known as peering points) between the first network 32 and the second network 34. Thus, data can travel from the first node 36 to the second node 38 via the first peering point 40 or the second peering point 42.

Furthermore, whether the first peering point 40 or the second peering point 42 is used, BGP still deems that the first node 36 is one hop from the second node 38 even though it might be the case that, for example, the first peering point 40 provides significantly better performance than the second peering point 42, since packets traveling via the second peering point 42 must travel much further.

Moreover, viewing network communications by network hops masks a second significant factor in attaining efficient network routing and that second significant factor is the quality of communications within each network including, for example, the number of routers that a communication must pass through to traverse each network, the speed of the communication media connecting those routers and the other demands placed on the routers and communication media. FIG. 2 illustrates the networks of FIG. 1, wherein the first network 32 includes routers 44, 46, 48, 50, 52, 54, 56, 58, 60, 62, 64, 66, and 68 and the second network 34 includes routers 70, 72, 74, 76, 78, 80, 82, 84, 86, 88, 90, and 92. As illustrated in FIG. 2, a message sent from the first node 36 may require, for example, router hops through four routers 82, 78, 76, and 72 to pass through the second network 34 and router hops through six routers 68, 64, 58, 48, 52, and 54 to traverse the first network 32 when routed through the second peering point 42.

Thus, there is a need for a method and a system that efficiently routes packets of data on a wide area network. There is a need to minimize router hops required to pass a message from an origination node to a destination node in a wide area network. There is also a need for an overlay network that efficiently routes data on a wide area network. There is also a need for a method of efficiently placing nodes on a network. Furthermore, there is a need for a method of calculating network metrics or performance characteristics of a portion of a network.

### SUMMARY OF THE INVENTION

In accordance with the present invention, methods and systems that efficiently route data on a wide area network are provided. In one embodiment, the present invention includes an overlay on a wide area network. The wide area network in that embodiment includes at least one backbone network, and the overlay includes a processor coupled to the backbone network. The processor furthermore contains instructions which, when executed, cause the processor to optimize real time performance of data delivery from the processor to another processor on the wide area network.

In accordance with another embodiment of the present invention, a method of optimizing at least two routes in a wide area network is also provided. The method includes optimizing a first route based on a first characteristic and optimizing a second route based on a second characteristic. The characteristics may be performance criteria including throughput, throughput variations, latency, latency variations, cost, network or processor hop count or any other measurable routing characteristic. The invention may furthermore optimize for a combination of two or more characteristics.

In accordance with yet another embodiment of the present invention, a method of selecting an optimum route from a first processor to a second processor in a wide area network and of selecting an optimum route from a third processor to a fourth processor in the wide area network is provided. The method includes selecting a first characteristic to be optimized in the route between the first processor and the second processor, measuring the characteristic on a first route coupling the first processor to the second processor, measuring the characteristic on a second route coupling the first processor to the second processor, and selecting from the first route and the second route, the route having the best performance based on the first characteristic. The method furthermore includes selecting a second characteristic to be optimized in the route between the third processor and the fourth processor, measuring the characteristic on a third route coupling the third processor to the fourth processor, measuring the characteristic on a fourth route coupling the third processor to the fourth processor, and selecting from the third route and the fourth route the route having the best performance based on the second characteristic.

In accordance with another embodiment of the present invention, a method for coupling nodes of an overlay network to a wide area network, wherein the wide area network includes a plurality of component networks is provided. That method includes coupling a node to a first local area network near a first peering point of the first component network, coupling a node to a second local area network near a first peering point of the second component network, coupling a node to the first local area network near a second peering point of the first component network, and coupling a node to a stub network.

Yet another method for finding a route having optimum throughput on a network of coupled processors is provided in accordance with the present invention. That method includes determining a size of a message sent along the route, determining a delay time required to pass a small amount of data along the route, and determining a duration of time required to pass the message along the route. Throughput of the route is then calculated from the message size, delay time, and duration. That method may furthermore include filtering delay time by measuring a delay time for a plurality of data passes along the route, calculating a mean absolute underestimated error for the plurality of delay time measurements, and selecting a delay time that minimizes the mean absolute underestimated error. Throughput may also be filtered in that method by measuring a throughput for a plurality of data passes along the route, and averaging the plurality of measured throughputs while weighting recent measurements more than earlier measurements.

Thus, the present invention provides an overlay that efficiently routes data on a wide area network.

The present invention also provides a method of optimizing routing on a wide area network based on at least two routing performance characteristics.

In addition, the present invention provides a method for efficiently coupling overlay nodes to a wide area network.

The present invention furthermore provides a method for finding a route having optimum throughput on a network and methods for filtering that measurement to make a more accurate route determination.

Accordingly, the present invention provides solutions to the shortcomings of prior networks. Those of ordinary skill in the art will readily appreciate, therefore, that those and other details, features, and advantages will become further apparent in the following detailed description of the preferred embodiments.

### BRIEF DESCRIPTION OF THE DRAWINGS

The accompanying drawings, wherein like reference numerals are employed to designate like parts or steps, are included to provide a further understanding of the invention, are incorporated in and constitute a part of this specification, and illustrate embodiments of the invention that together with the description serve to explain the principles of the invention.

In the drawings:

FIG. 1 is a schematic illustration of two interconnected networks;

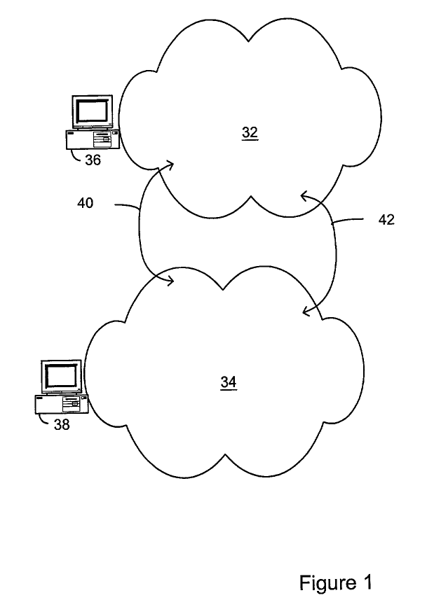

FIG. 2 is a schematic illustration of the interconnected networks of FIG. 1 including routers located within each network;

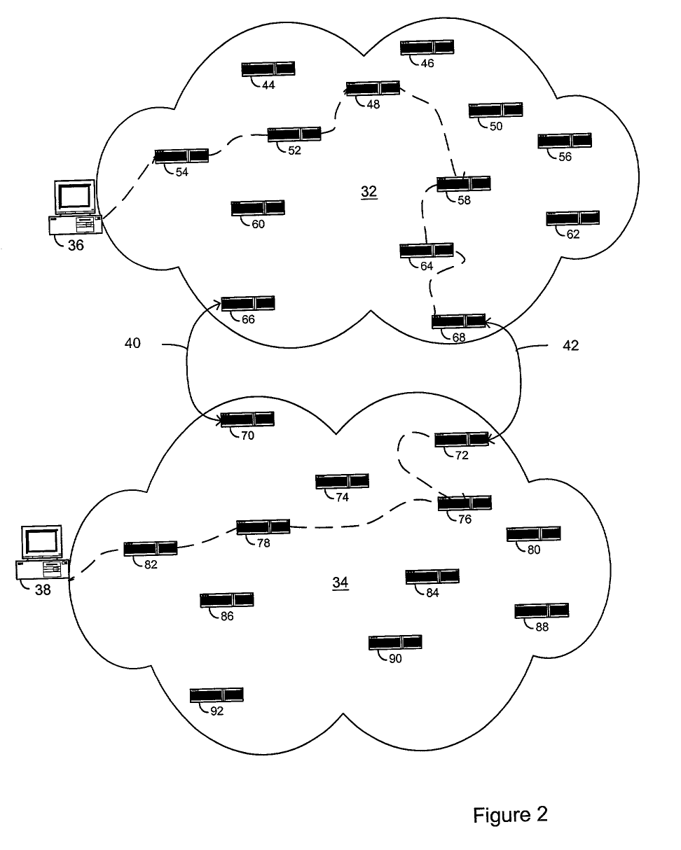

FIG. 3 is a schematic illustration of a sample wide area network topology;

FIG. 4 is a schematic illustration of the sample wide area network topology of FIG. 3 having an overlay of the present invention;

FIG. 5 is a schematic illustration of the sample wide area network topology having an overlay of FIG. 4, illustrating an alternate route through the network;

FIG. 6 is a schematic illustration of sample networks in which overlay nodes have been placed in accordance with the present invention;

FIG. 7 is a schematic illustration of the sample networks of FIG. 6 in which overlay nodes have been placed in accordance with another embodiment of the present invention;

FIG. 8 is a schematic illustration of sample networks in which overlay nodes have been placed in accordance with another embodiment of the present invention; and

FIG. 9 is a time line illustrating a method of determining network latency.

### DETAILED DESCRIPTION OF THE INVENTION

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical computer networks.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment.

The present invention exploits the many paths available to transmit data between any two points on a network such as the Internet to provide better service to users in addition to permitting recovery from interconnection failures. That concept may be likened to taking a highway when it is under utilized and taking a back road when the highway is heavily utilized. Similarly, the present invention improves service to users by shifting data away from overloaded areas of the network toward under-utilized areas, thus improving network performance.

The present invention recognizes that not every network user has the same notion of what constitutes a significant improvement in network performance. For example, improved performance for the user of one type of application might be for data transferred by that user over the network to experience low latency when it is sent through the network. Network latency is the time that it takes for a small piece of data to travel across a network such as, for example, the time it takes for a packet of data to travel along a route on the Internet or another network. Network latency is also referred to herein as “packet delay,” whereas duration refers to an amount of time that is required to send a particular quantity of data, such as a message comprising a large number of packets, along the route. A user of another type of application may view a high throughput as a significant improvement in network performance. Network throughput is an amount of data that can be transferred across a network communications channel in a given period of time, which is usually expressed in units of bytes per second. Yet another user of a third application may prefer a combination of relatively low latency and high throughput. Thus, the improved network of the present invention may take into account the characteristics of the application from which the data originates to improve effectiveness in improving performance. It should also be noted that, while the embodiments discussed herein optimize network routing performance metrics including latency and throughput, other routing metrics may also be optimized using the present invention.

The improved network of the present invention provides application-specific routing which utilizes alternate paths through the Internet that the Internet's current routing protocol is unable to support. Furthermore, unlike proposed routing algorithms or infrastructures that would require cooperation of all network operators to implement, the present improved network does not require that significant global changes be made to the network. The present invention, rather, provides improved application-specific routing without any changes to existing networks or the existing Internet.

The system of the present invention fulfills several goals. First, it uses performance metrics that directly predict application performance, also referred to herein as network characteristics and performance criteria, including latency, throughput, variation in latency, variation in throughput, cost of transferring data, and processor hop count wherein the processors may be overlay processors, to choose paths through a network, in addition to metrics which can be used to approximate application performance such as network hop count or packet loss rate. The present invention also does not require any modifications to Internet protocols or routing algorithms. The present invention furthermore scales well.

### Overlay Network

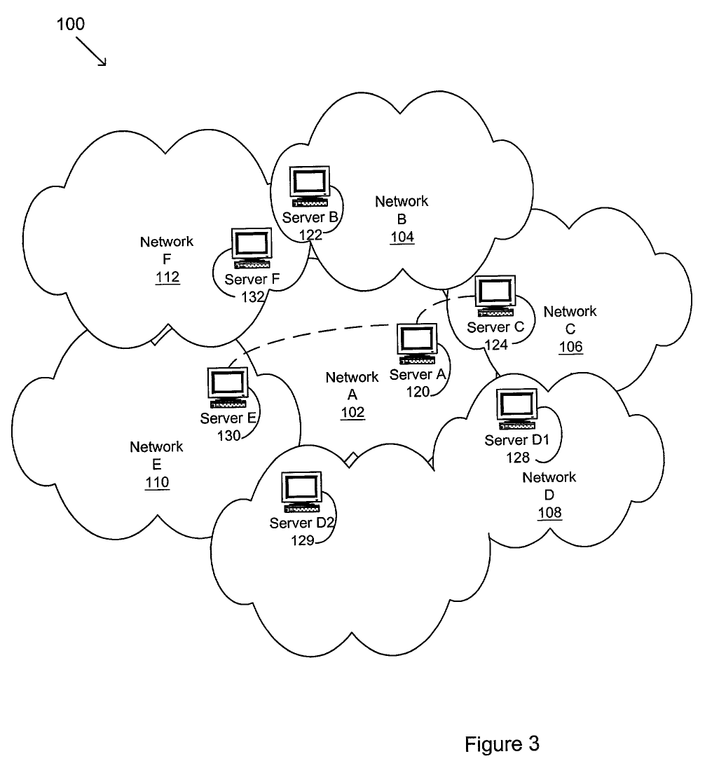

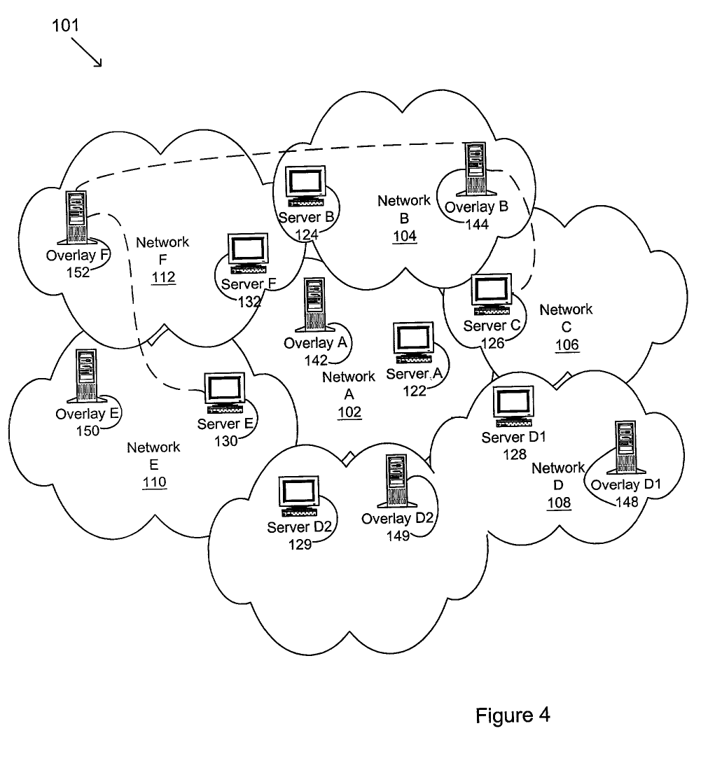

While certain of the embodiments described herein are described in connection with the Internet, it should recognized that the present invention may also be applied to other wide area networks. A foundation of the present invention is to build an overlay network that functions in association with a target-wide area network such as the Internet. An overlay is a virtual network including a group of processors coupled to the target network such as the Internet. The main differentiation between an overlay and other groups of servers is the way that the processors of the overlay (also known as “nodes”) model the underlying network. In the present invention, each node treats the network as a set of direct connections to all the other nodes. In reality, each “direct link” from one node to another is a path through the network, which passes through all the same routers, switches, and cables through which standard packets would otherwise pass without existence of the overlay. Thus, for example, to send data to a neighboring node, a node coupled to the present network will address a packet to the neighbor node and will then send it over the network. In other words, the underlying network is utilized by the overlay exactly as it is by any other node on the network. FIG. 3 illustrates a typical wide area network topology 100 that does not include an overlay network of the present invention. The wide area network 100 is comprised of Network A 102, Network B 104, Network C 106, Network D 108, Network E 110, and Network F 112. Each of those networks 102, 104, 106, 108, 110, and 112 may be a component network such as, for example, a backbone network, a stub network, or a local area network. A stub network is a network that only deals with traffic to or from the nodes directly attached to it. Examples of stub networks include most of the ISPs that sell Internet access directly to individuals. Such ISPs often deal only with data sent to or from its customers. The opposite of a stub network is a transit or backbone network that routes traffic from one network to another rather than to destinations on its own network. In a wide area network such as the one illustrated in FIG. 3, a message traversing multiple networks will typically be sent in such a way so as to minimize the number of network hops. Other routing considerations such as router hops and network congestion, however, are not typically considered. Thus, if the route indicated in FIG. 3 from originating node Server E 130 through Server A 120 to destination node Server C 124 is congested or requires a large number of router hops, that small network hop route may be inefficient. FIG. 4 illustrates the network topology of FIG. 3 with an overlay of the present invention. In FIG. 4, Overlay A 142 is an overlay server coupled to Network A 102, Overlay B 144 is an overlay server coupled to Network B 104, Overlay D1 148 and Overlay D2 149 are overlay servers coupled to Network D 108, Overlay E 150 is an overlay server coupled to Network E 110, and Overlay F 152 is an overlay server coupled to Network F 152. Overlay servers may be placed at strategic locations on the wide area network such that certain networks within the wide area network may include no overlay servers, while other, particularly busy or useful networks may include multiple overlay servers. A benefit to such an overlay is that the overlay servers may include a facility for determining the performance of network routes and may route network traffic around poor performing, for example, congested areas of the wide area network. Thus, in an overlay network, where performance of Network A has been determined to be poor, a message to be sent from Server E 130 to Server C 126 may be routed through Overlay F 152 and Overlay B 144 rather than through Overlay A 142 in underperforming Network A 102.

The present invention exploits the potential usefulness of alternate paths through a network to improve network performance with regard to, for example, latency and throughput and utilizes an overlay to exploit those paths.

Performance requirements vary dependent upon the type of application being modeled and the specific needs of each of those applications. The overlay network of the present invention takes those differences in performance requirements into account when choosing a data route from one node to another node. For example, some links may be modeled to optimize throughput, while other links might be modeled to optimize latency, and still others might be modeled for a combination of high throughput and low latency. The present overlay network may, thus measure various characteristics or metrics for each of a variety of links, including throughput and latency, and choose appropriate routing for any of a variety of applications having differing optimization needs. That implies that the route with the best performance from one node to another may not always be via the most direct link between the two nodes. Instead, the way to maximize performance may be to send data through several other nodes in order to avoid links with poor performance.

### Node Placement

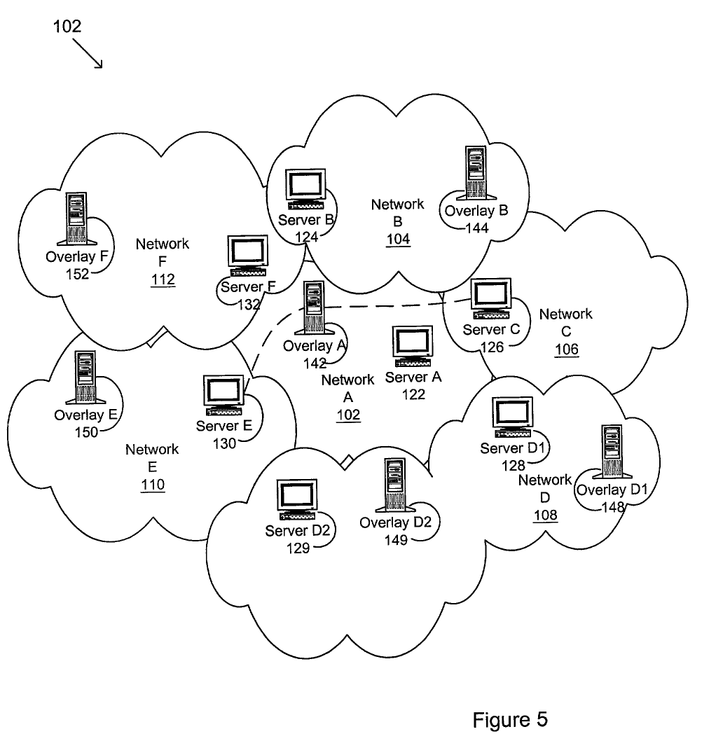

When nodes of the overlay are placed at many locations throughout the wide area network, then the overlay can control how packets are routed from one portion of the wide area network to another by routing the packets through nodes of the overlay. FIG. 4 illustrates one route through a sample overlay network 100 from Server E 130 to Server C 126. FIG. 5 illustrates an alternative path from Server E 130 to Server C 126 through the sample overlay network 100.

Assuming for the present example that Network A 102 is congested, it may be more efficient to route data passing through the overlay from Server E 130 to Server C 126 through Network F 112 and Network B 104 as illustrated in FIG. 4 than to route that data through Network A 102 as illustrated in FIG. 5. A feature of the present overlay network is the ability to measure wide area network performance, including Internet performance, to determine most efficient routing. Thus, when Network A 102 is congested, the route from Server E 130 to Server C 126 through Network A 102, illustrated in FIG. 5, passes through congested Network A 102. By routing from Server E 130 to Server C 126 via uncongested Overlay F 152 and Overlay B 144 as illustrated in FIG. 4, greater efficiency may be achieved. Thus, even though the path through Network F 112 and Network B 104 requires more network hops than the path through Network A 102 and involves more nodes of the overlay, performance may be improved, because the route through Network F 112 and Network B 104 avoids the congested portion of the network 100. Thus, routing packets through the overlay nodes gives control over how the network routes the packets, thereby allowing packets to use the path with the best performance.

Proper node placement also improves the operation of the invented system. While node placement may be determined in many ways, three techniques for deciding where to place nodes are discussed herein. Each of those techniques may furthermore supplement the other techniques, such that better results may be achieved by using all the techniques simultaneously. In addition, when more nodes are placed in the network, greater control over routing can be achieved.

A node that sends an original message or packet will be referred to herein as an originating entity, a node to which the message or packet is to be finally transmitted will be referred to herein as a destination entity and a node that receives a message or packet and passes that message or packet on toward the destination entity will be referred to herein as a transfer entity. Packet loss occurs where a packet of data is transmitted to a transfer entity but is not transmitted from that entity. Such a loss may be caused, for example, by defective communication media or a defective transfer entity. When a message or packet is not received at the receiving entity, the receiving entity will typically request that packet be retransmitted from the originating entity.

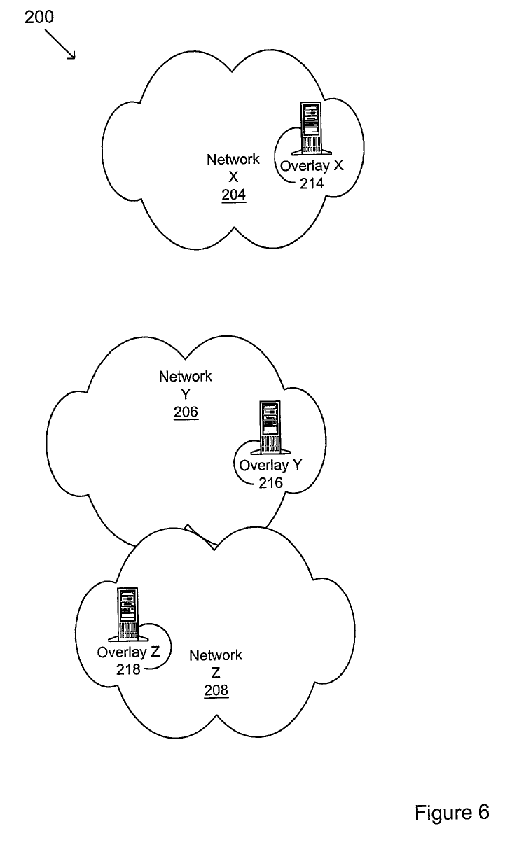

FIG. 6 illustrates a first technique for deciding where to place nodes, wherein nodes are placed on different networks within a wide area network. In the network overlay embodiment 200 of FIG. 6, Overlay X 214 has been coupled to Network X 202, Overlay Y 216 has been coupled to Network Y 206, and Overlay Z 218 has been coupled to Network Z 208 of a wide area network 200 in FIG. 6. Placing nodes on networks of multiple providers allows the overlay to “route around” providers whose networks are currently performing poorly by directing traffic to nodes installed in neighboring networks. That is a fairly coarse-grained path selection technique since it only gives a choice of provider, not a choice of paths within the network of each provider.

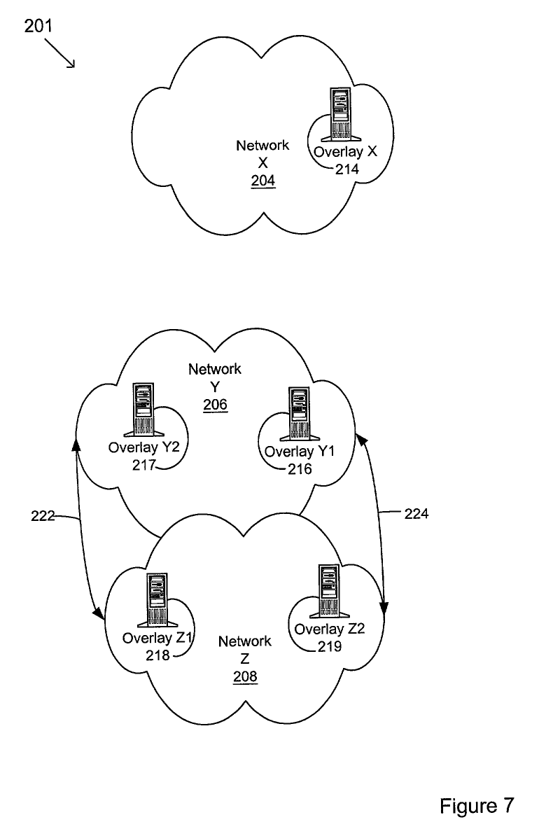

FIG. 7 illustrates a second technique for deciding where to place nodes. In that second technique, nodes are placed at different points within individual networks that are coupled to other networks comprising a wide area network. Many large network providers, particularly backbone and stub network providers, have multiple peering points at which they connect to another provider's network. In the peering point network 201 of FIG. 7, peering points are defined from a network to network perspective, such that peering points exist in a wide area network where two or more networks are coupled together to exchange traffic. Thus, where a processor on a first network is coupled to a processor on a second network, those processors comprise a peering point. The exchanges that occur at peering points include the transfer of network packets to be delivered to servers on a network participating in the peering point and may also include the transfer of network packets that are delivered by a network at the peering point to other networks not involved with that particular peering point. Many researchers have observed that it is at these peering points or transfer entities that most packet loss occurs resulting in slow transmission. However, at any given moment, only some peering points may be experiencing congestion, while others remain relatively idle, passing much less than their capacity of messages and packets. By placing nodes near multiple peering points in a provider's network, the peering point through which data passes can be controlled. FIG. 7 illustrates an example of this scenario wherein Network Y 206 and Network Z 208 are interconnected as peers at two locations 222 and 204. One portion of Network Y 206, therefore, would typically use one peering point 222 to communicate with Network Z 208 and another portion of Network Y 206 would typically use peering point P1 to communicate with Network Z 208. Thus, by including an Overlay in each portion of the Network Y 206 and an Overlay in each portion of Network Z 208, the present network can choose whether to communicate through either peering point 222 and 224. The present network may furthermore be configured such that sending data to Network Y 206 via Overlay Z1 218 will ensure that the first peering point 222 is used, while sending data to Network Y 206 via Overlay Z2 217 will ensure that the second peering point 224 is used.

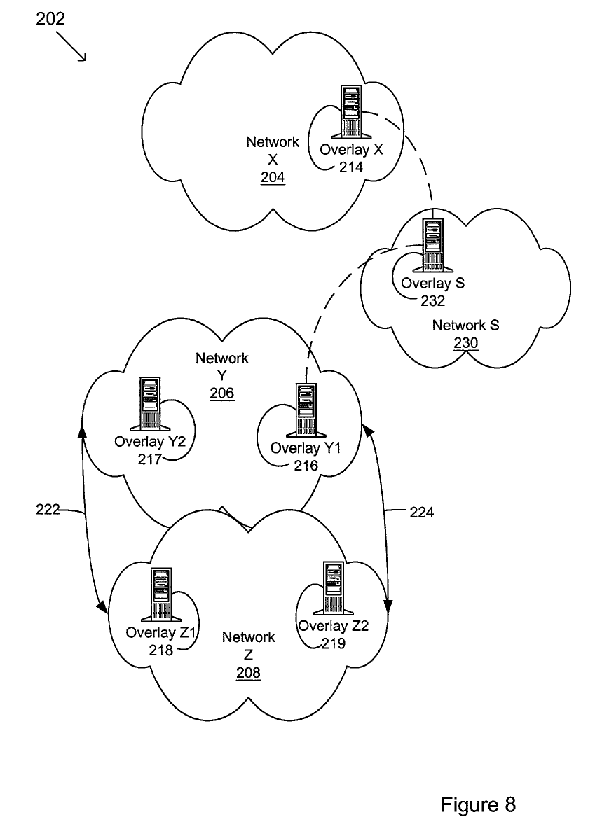

FIG. 8 illustrates a third technique for deciding where to place nodes. In the transit and stub embodiment 202 illustrated in FIG. 8, Overlay S 232 is placed on a stub network labeled Network S 230. A stub network (Network S 230) is coupled to multiple backbone networks via overlay nodes (Network X 204 by way of Overlay X 214 and Network Y 206 by way of Overlay Y 216). Putting a node on a well-connected stub network can effectively convert it into a transit network for purposes of the overlay. In FIG. 7, Network X 204 has no direct route of communication with Network Y 206 without the overlay network. Both may, however communicate with stub network Network S 230. It may be, for example, that without the overlay network, Network X 204 and Network Y 206 only send data meant for Network S 230 to Network S 230. Thus, Network S 230 would not ordinarily pass data from Network X 204 to Network Y 206 or vice versa. By placing a Overlay S 232 on Network S 230, however, an artificial peering point between Network X 204 and Network Y 206 can be created, through which traffic can be routed between Network X 204 and Network Y 206 via Overlay S 232.

### Applications of Overlay Network

The present overlay network may be deployed to enhance many network applications and may be particularly applicable to applications that require high-speed data transfers across the Internet. For example, the present overlay network is applicable to content delivery over the Internet. Inside a typical content delivery system, there are multiple types of data, each with its own routing metric preference. A low latency path with moderate throughput is typically appropriate for static content (e.g., HTML or embedded images) being transferred from a web site to users located conceptually at the edge of the network. (Conceptually, Network Access Points and Internet Service Providers are at the core on the Internet, content delivery and Internet marketers are outside the core, and users are at the edge of the Internet.) Low latency and moderate throughput are typically appropriate for static content because static content is usually relatively small as compared, for example, to dynamic content such as streaming video and audio. Whereas streaming video and audio often requires high throughput so that data is received at a minimum rate after the first data is received to keep the video and audio running continuously, static content need only load a static display, thereby minimizing throughput requirement to maintain timely receipt at a user processor over time.

Logging information concerning how often a web site's content is being accessed, on the other hand, is typically sent from the edge of the network back to the web server and benefits from a high throughput path. A typical small log entry of ten to one hundred bytes for each of several million users forms a huge compilation of data as compared to, for example, a ten to two hundred kilobyte web page download file. Thus, high throughput is required to pass large logs of information from servers at the edge of the network to a central server.

Invalidations, which tell edge devices when content is no longer valid (e.g., to purge an old version of a home page from numerous content delivery devices residing at the edge of the network), benefit from a low latency path. Invalidation messages are typically very small and thus have minimal throughput requirements. It is typically important that invalidation messages be received quickly because they prevent old or invalid data from being sent to user processors. Thus, low latency is important when invalidating data to quickly prevent such old or invalid data from being forwarded to users.

The present invention can accommodate the needs of all of those data types and others simultaneously by keeping different routing metrics and a different routing table showing the most efficient routing for each type of content that passes through the system.

The present network overlay may also be applied to IP telephony. Though a telephone call requires a relatively small amount of bandwidth (typically less than 30 Kbps), it has strict delay and jitter requirements such that delays larger than 150-200 ms are generally considered intolerable. By using a routing metric which selects paths with low latency and jitter, the present network overlay can improve the sound quality that an IP telephony user receives.

The present network overlay may also be applied to file sharing such as MP3 sharing through a service such as Napster. Many file-sharing applications deal with large files that are greater than 1 MB. A key to improving performance for such file sharing applications is to transfer files between users' computers using high-throughput paths through the network. High-throughput paths are beneficial to file sharing applications because those files are relatively large and large amounts of data may be moved through high-throughput paths quickly. Latency, on the other hand, is of less concern in transfers of such large amounts of data because a typical latency delay of milliseconds to a second or so is less significant than the several second transfer time difference between high and low throughput routes. The present network may be configured to find high-throughput paths, and is thus well suited to providing connectivity for file sharing applications.

The present network is also well suited to bulk data transfer applications such as digital movie distribution. Such applications are very similar to file sharing, except that the file size in digital movie distribution is often in the range of 10-100 GB per file and is thus even larger than typical file sharing applications. One example of bulk data distribution is transferring a movie (in digital format) from a production studio to a number of movie theaters. Finding high throughput paths is vital to efficient transfer of such large files, but another key tactic to improving bulk data transfer operation is to split a single file into a number of pieces and send those pieces over multiple paths in the network. By using multiple paths, one can achieve throughput greater than that of any single path.

In one embodiment, a deployed form of the present network that might be utilized to achieve such a multi-path transfer has an architecture consisting of two types of computers, each with its own software. The first type of computer is a server and one or more of those servers would be deployed on a network as a basic overlay. The servers would be placed strategically on the network as discussed hereinbefore to maximize performance of the network. Those servers would run software that implements optimized overlay routing and data transfer.

The second type of computer in a bulk transfer or similar implementation of the present invention could be employed by users to connect to the overlay network. Those user computers may run application software to inter-operate with the overlay network. The servers may furthermore be operated by a network service provider, and the user computers may run application software provided by the network service provider. Accordingly, the servers may run software that is concerned with data movement, while the user computers run software that is concerned with processing data received from the overlay and presenting the results to the user. For instance, with file sharing applications, the server software may control the transfer of music files over the network while the user software may allow the user to control functions including which files are downloaded next and which files are played back through the computer's audio system.

There is a range of homogeneity of function possible in deploying the present overlay network. At one end of this range, all computers participating in the system run the same software, and all computers act as nodes in the overlay. That version of the system is simple to build because only one machine type and software package need be created and replicated. That version also provides good performance because every computer in such a system includes route optimizing software. A system wherein all computers run the same software may be more difficult to deploy, however, because it requires distribution of a full version of the overlay software to all users' machines. In addition, that system may be vulnerable to abuse by users who might forge routing messages with the intention of disrupting the system.

At the other end of the range, users' computers may run a slimmed-down version of the overlay protocols while the servers run the full version. The slim version of the system may provide bare connectivity between each user's computer and an overlay server with no routing logic whatsoever. That bare functionality may be provided by a web browser or multimedia viewer (e.g., RealPlayer or Windows Media Player). In that version of the system, the system itself must direct the users' computers to a suitable overlay server. That can be accomplished using redirection of users' computers to servers. One example of such a service is the front end of Akamai's content delivery system, which provides a redirection service built on top of a Domain Name Service (“DNS”).

To optimize routing, the present improved network distinguishes among the available paths between any two processors on the Internet, recognizing that some paths will have low latency, others will have high throughput, and still others will offer a balance between latency and throughput. The present network may then save network metric data including latency and throughput for each available path. Thus, the present network and method of using a network selects the most appropriate route for each application or application type by matching data to the most appropriate path to improve the routing of that data as it is sent through the network according to particular requirements of the application.

### Automatically Finding Superior Paths

The present invention also finds the best routes from one node to every other in a scalable fashion in a system having a collection of nodes forming an overlay. The techniques utilized by the present invention are an adaptation of the Narada protocol, which may be found in “A Case For End System Multicast” which is incorporated herein by reference. Yang-hua Chu, Sanjay G. Rao, and Hui Zhang, A Case For End System Multicast, in PROCEEDINGS OF ACM SIGMETRICS 1-12, Santa Clara, Calif., (June 2000).

The present network solves the scalable routing problem of finding an optimum path between an originating entity and a destination entity. The network considers the processors and communication media coupling those processors and determines desired performance characteristics between the processor nodes. Thus, given a collection of processor nodes and a collection of links with particular performance characteristic between each pair of nodes, the present invention will find a path between each pair of nodes that achieves the desired performance characteristics. The present invention may be applied as an overlay on the Internet or another wide area network, wherein overlay processors comprise nodes and the links are the connections from each node to every other node. Moreover, standard Interior Gateway Protocol (“IGP”) algorithms such as RIP and OSPF do not address the challenge of collecting performance measurements for each link.

As has been previously discussed, the performance characteristics or network metrics that are desired to be optimized, such as, for example, latency or throughput, may vary from one application to another. Thus, various apparatuses and methods may be utilized to make a determination of the performance characteristics between nodes based on one or more desired performance characteristics or routing metrics.

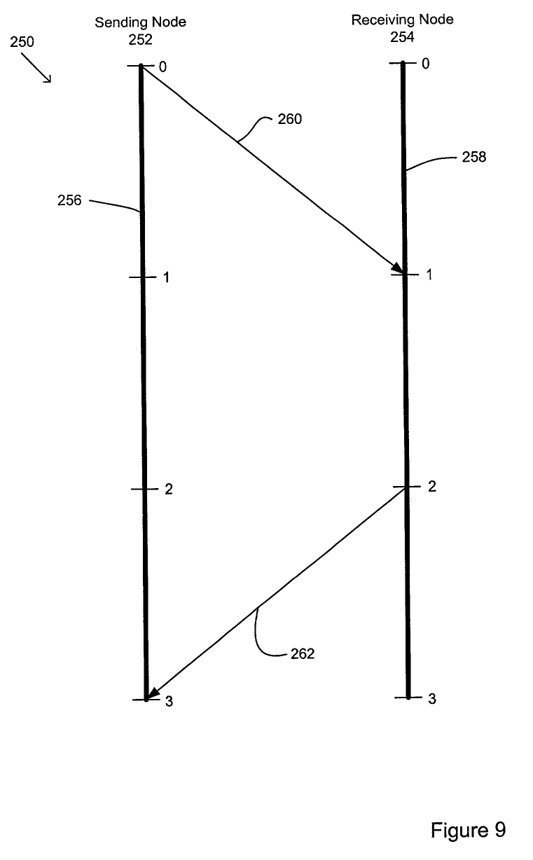

Pinging, for example, may be utilized to measure latency between nodes of a network. Network latency testing may be performed utilizing publicly available systems including ping programs. Ping programs typically send an echo request message to a selected IP address and provide information including the IP address from which an echo reply message was received; a sequence number of the message starting at 0, wherein each missing number indicates a lost packet from either the echo request or echo reply message; a time to live field that indicates the number of router hops made by each packet in the message; and a number of milliseconds it took to get a reply from the IP address being pinged. FIG. 9 illustrates a method of determining network latency. A sending node time line 256 for a sending node 252 and a receiving node time line 258 for a receiving node 254, which is coupled to the sending node 252 through a network, are depicted in FIG. 8. Each of the sending node time line 256 and receiving node time line 258 have corresponding time 0, time 1, time 2 and time 3. At time 0, the sending node 252 sends an initiating message 260 to the receiving node 254. The receiving node 254 receives the initiating message at time 1. That initiating message 260 requests that the receiving node 258 return a message to the sending node 256. At time 2, a return message 262 is sent to the sending node 252 by the receiving node 254. The return message 262 is received at the sending node 252 at time 3. After receiving the return message 262, the sending node 252 will compute the “round trip latency time” which is equal to the difference between the time that the return message 262 was received at the sending node 252 (time 3) and the time that the initiating message 260 was sent from the sending node 252 (time 0) less the difference between the time that the return message 262 was sent by the receiving node 254 (time 2) and the time that the initiating message 260 was received at the receiving node 254 (time 1).

Because the time required to send a message from a sending node in a network to a receiving node in a network is typically very similar to the time that it takes to send a message back from the receiving place to the sending place, network latency from the sending node to the receiving node may be assumed to be half of the round trip latency time. Similarly, network latency from the receiving node to the sending node may be assumed to be half of the round trip latency time. Thus, a “one-way latency time,” which is also referred to hereinafter as the “latency time” or “packet delay” for a message or packet of data to travel from the sending node to the receiving node or from the receiving node to the sending node is calculated by dividing the round trip latency time by two. The calculation for one way latency time may, therefore, be expressed as:

OWLT=((T3−T0)−(T2−T1)) /2,

where

OWLT is one way latency time;

TO is the time that the initiating message is sent as determined by a clock at the sending node;

T1 is the time that the initiating message is received as determined by a clock at the receiving node;

T2 is the time that the return message is sent as determined by a clock at the receiving node; and

T3 is the time that the initiating message is received as determined by a clock at the sending node.

Thus, because relative time differences are calculated at each node, as long as the clocks at the sending node 252 and receiving node 254 operate at the same speed, the clocks at the sending node 252 and receiving node 254 do not need to be set at the same time to assure that the calculation is accurate.

Network latency encountered in a network such as, for example, the Internet, may be caused by such factors as the number and size of messages traveling (commonly referred to as an amount of “traffic” or “activity”) on the network, the distance the message must travel, the number of routers through which the message must pass and the level of functionality of those routers, the network bandwidth, and the number of lines that are available as opposed to being busy or out of operation. Moreover, the factors affecting network latency vary continually. Thus, network latency varies from the time when one message is sent to the time another message is sent. Network latency often, however, is fairly stable over periods of time, such as the time required to send the packets that make up a large message. Therefore, depending on the accuracy desired, latency may be calculated by, for example, a single test as described in reference to FIG. 9, an average of several tests, a highest or lowest latency determined from a number of latency tests, or a running average that averages only a certain number of most recent tests. Network latency may also be estimated by reference to average statistics for a region at, for example, a network dashboard Internet site.

Throughput may, for example, be tested by utilizing publicly available systems including Test TCP programs, also known as “TTCP,” programs. TTCP programs typically send and receive data in one or more formats such as, for example, transmission control protocol. A TTCP user may have control over parameters including the number of packets sent, the packet size, the port number at which the transmitter and receiver rendezvous, and several other parameters. By changing those parameters, a user can test various buffering mechanisms in the network equipment between the sending node and the receiving node, including throughput.

Thus, certain qualities of network connections may be measured, including packet delay, throughput, duration of packet travel time, and packet size. Moreover, certain of those qualities are interrelated such that, for example, duration is equal to packet delay plus the product of throughput times packet size or:

Duration=packet delay+(throughput*packet size).

Furthermore, as throughput is an amount of data that can be transferred across the network in a given period of time, an equation relating duration to throughput may be rewritten as:

Throughput=packet size/(duration—packet delay).

Thus, once packet size, packet delay, and duration have been determined, throughput may be calculated for that route by sending a large amount of data having a known size along a route having a known packet delay, measuring the total transfer time that is required to pass the entire message to a desired destination, and calculating throughput therefrom.

Each route to be considered may be thus evaluated and the route having the highest throughput may be utilized. The most efficient routing may be calculated for packet transfer by selecting the routes having the highest throughput.

Thus, to contrast packet delay and throughput in an application in which a large amount of data is requested to be sent to a user across the network, packet delay goes to the amount of time that it takes for each packet to travel from the origin to the destination, which might be seen by a user as an amount of time, for example, for a requested motion picture from a network processor to begin appearing at the user processor, while throughput goes to how much data is passed across the network in a period of time and might be seen to a user as continuous motion in a high throughput instance or stop motion that periodically stops and restarts in a low throughput instance.

The size of the packet can be ascertained by reference to the packet and the duration of the packet travel time may, as previously discussed, be determined by sending a request for a return message and halving the round-trip message travel time. Thus, a first step in calculating duration may be to send a message of known size along a route that is to be evaluated and requesting a return message. Duration is then equal to half of the round-trip message travel time less the packet delay time.

Packet delay may vary from test to test. Therefore, it is beneficial to smooth or filter the calculated packet delay. Packet delay smoothing may be performed by, for example, minimizing the mean absolute underestimated error of a group of packet delay readings. Use of minimization of the mean absolute underestimated error was found experimentally after experiments in minimizing mean squared error resulted, in certain cases, in negative latencies which, of course cannot exist. Use of results in the third to tenth percentile was also found experimentally and results in a measurement that represents delay time that includes minimum queuing at bottlenecks in the network such as routers, while eliminating the lowest measurements which have been found to frequently include error. Thus, for example, a reading falling in the third to tenth percentile may be selected as representative of packet delay by taking twenty sample readings and utilizing the second lowest reading as representative of actual packet delay.

Throughput may also vary from test to test. Therefore, it is also beneficial to smooth the calculated throughput value. To smooth throughput it is beneficial to average throughput measurements received in a number of tests. Furthermore, because throughput is dependent on activity and network performance characteristics that change over time, it is beneficial to weight more recent measurements more than measurements made earlier. Thus, a new throughput measurement may be weighted at three percent of a smoothed throughput value while the previous smoothed throughput value is weighted at ninety-seven percent of the smoothed throughput value.

That calculation may be represented by the equation:

Smoothed throughput=(1−lambda)*previous smoothed value+lambda*current throughput measurement;

wherein lambda is equal to 0.03. In such an equation with lambda set at 0.03, a measurement will decay to half its original contribution after approximately 23 measurements.

An aspect of the present invention addresses the concept of a scalable network. Scalability can be defined as a measure of overhead per work done. In the case of an overlay, scalability may be defined to be a sum of the cost of the number of processor cycles and cost of the number of bytes sent on a network used to configure links of the network, divided by the number of bytes of data transferred for purposes of an application run by users. For example, many processor cycles are required to compute the best route between each pair of nodes on a network. In addition, it may be the case that each node in the overlay needs to exchange its routing state with other nodes by sending the routing state over the network. Thus, by minimizing both the number of processor cycles and the amount of traffic sent over the network, scalability may be maximized.

The number of processor cycles used and the number of bytes sent on the network are a function of three quantities: the number of nodes in the overlay; the number of links which each node maintains; and the number of updates to the node's routing state sent per minute. To make a truly scalable overlay, these three quantities must be minimized. However, the final quantity, the number of updates sent per minute, is a function of how frequently and to what extent network performance changes. Potentially, every time performance changes, every node in the network could be updated. Because control over the frequency of network performance changes is often lacking, the focus of the present invention is on optimizing the number of nodes and the number of links, which are discussed herein in turn. Prior overlays do not employ schemes to minimize both the number of links and the number of nodes and as a result are not scalable to the extent of the present invention.

Each node in an overlay typically maintains information about the best routes to use to reach every other node in the overlay. By minimizing the number of nodes in the overlay, the processing overhead to compute and store these routes is reduced. In a non-overlay network, the number of nodes in the network is directly related to the number of users of the network and cannot be altered. An overlay, however, can consist of just one node. Additional nodes can be added to increase performance and reliability of the overlay. The node placement schemes presented above lead to nodes being placed only where they are needed to improve performance, hence the number of nodes is kept to the minimum required to achieve a given level of performance.

If there are N nodes in an overlay, then there are N*(N−1)/2 links connecting those nodes. Common IGP algorithms have run times that are proportional to at least the square of the number of links in the network because they are based on algorithms for computing shortest paths through graphs. See Thomas H. Cormen, Charles E, Leiserson, and Ronald L. Rivest INTRODUCTION To ALGORITHMS, MIT Press, Cambridge, Mass. (1990), which is incorporated herein by reference in its entirety. Thus, computing the routing for a network having 1000 nodes will take 100,000,000 times longer than computing the routing for a network having 10 nodes. The increase in running time required to compute routing metrics becomes intolerable if the overlay is to scale to thousands of nodes. One approach to solving the scalability problem includes modifying the routing algorithm, and another approach includes reducing the number of links in the overlay.

In a certain embodiment of the present invention, the number of links considered by the routing algorithm is reduced. That permits the use of standard routing algorithms that are known to work well. Architecturally, the present invention may utilize a two layer routing system, wherein the upper layer is a standard IGP algorithm and the lower layer is equivalent to the link layer in a standard network, wherein that lower layer manages the links of the network. However, unlike a standard network, links in the overlay can be added or deleted at any moment. Thus, the goal of the link layer in that embodiment is to maintain only a few links per node while still finding paths which improve performance. Three to ten links may, for example, be appropriate for a network of 100 nodes. The present invention may periodically measure the performance of the overlay links and then the routing algorithm may be run to choose which links to use to reach each node. Meanwhile, the link layer may also periodically add and drop links to try to improve the set of links fed to the routing algorithm while minimizing the total number of links a node maintains. Thus, the present overlay network is scalable to hundreds or thousands of nodes.

The lack of managed links has prevented large networks from considering extensive network performance metrics. In order to take performance metrics (such as latency and throughput) into account when routing packets through an overlay, it is necessary for nodes to exchange performance data with other nodes via some routing protocol. Since performance data changes relatively quickly (as fast as every few minutes), nodes should also exchange data at least every few minutes. That exchange can lead to a significant overhead per network node. The present overlay network is designed to be scalable such that it may contain hundreds to thousands of nodes, such that the total overhead of using performance data is manageable. In contrast, the Internet, which has millions of routers, is not currently able to use extensive performance data because its links would be overwhelmed with performance updates.

To improve the performance of the overlay, the overlay may periodically alter the links utilized by the nodes of the overlay. In one embodiment, for example, the link layer of a node X of the present invention may periodically choose a new node, Y, from a list of all the nodes in the overlay to which X does not currently link. X may then establish a link to Y and measure the performance of that link.

To compute the performance of a route using a link, one or more packets from the origination node of that route to the destination node of that route that would normally pass through node X through a known link to a node Z are directed instead through the X to Y link. The route followed from Y to the destination node may be plotted by, for example, standard Internet routing such that nodes X and Y may be nodes on the overlay communicating over the wide area network to which they are coupled, and the route from Y to the destination node may pass through all non-overlay nodes on the wide area network. The route from node Y to the destination node may be determined at the Y node by reference to a Y node routing table. Thus, the characteristics of the new route from the origination node to the destination node in this example is equal to a combination of the characteristic of the existing link from the origination node to node X, the characteristic of the new link from node X to node Y, and the characteristic of the standard link from node Y to the destination node. It should be recognized that an existing route from a node A on the overlay to the destination node may be combined with a new route from the origination node to node A, as well.

The extent of improvement, if any, that may be realized by utilizing the link to Y may then be calculated. That calculation may be carried out by first determining which routes to other nodes could use the new link. Such route use may be determined by invoking a commercially available routing algorithm. Each route may then be compared to one or more existing routes and, if the percentage of routes that are improved is larger than an “add” threshold, Ta, then the new link may be retained or may replace an existing route. That add threshold, Ta, may, for example, be set such that at least forty percent of all routes are improved by use of the new link. If the new link isn't determined to provide a significant performance benefit, the calculation may also be performed from the perspective of node Y (this is possible because X and Y inform each other of their routing state). If the new link improves Y's routing by more than Ta, then the link may be retained. If neither node's routing state is improved significantly, then the new link will typically be dropped and the existing links will be retained.

A database of optimum routes having known characteristics may be maintained by a processor or each processor comprising an overlay network of the present invention. As has been discussed, different routes may be optimized for different characteristics even though the origination and destination nodes are the same. When making a determination as to whether routes utilizing a new link should be added to that database, a person or processor may select a node X having a routing table containing a list of existing routes to all known destination nodes and expected performance characteristics for each of those routes. To evaluate a new link between node X and another node Y, nodes X and Y exchange routing tables, thereby providing information regarding how to route information to each node. The present network may then cause nodes X and Y to measure the performance of certain desired characteristics or metrics applicable to routes between those nodes. For example, throughput and/or duration may be determined for the X to Y and Y to X links. The result of the testing might be a determination of a single optimum route for each desired metric. Thus, a high throughput route may be established, a short latency route may be established, and a route having a combination of relatively high throughput and short latency may be established. It should be recognized that those routes may furthermore be the same or different routes.

The bandwidth for the route defined in the above example that proceeds from the origination node to node X, to node Y, to the destination node, is equal to the minimum of the bandwidths of each of those three routes. Moreover, the latency of that route is equal to the sum of the latencies of the route from origination node to node X, the route from node X to node Y, and the link from node Y to the destination node.

Next, for each destination node, the performance of the node X to node Y link will be compared to one or more currently preferred routes. A score may be maintained as that comparison takes place such that, when a new route achieves a high score, that route may be used for future transmissions. Thus, each time that a route to a destination through the X to Y link is tested and the performance of the route is better than the performance of previously used routes, the score of the X to Y link may be incremented. To increment a link score, it may be required that the improvement over existing routes be greater than a score threshold which may be denoted as “Ts.” If the route including the X to Y link does not improve the performance of a transfer to the destination node by at least the amount of the threshold, the score would conversely not be incremented. The result is that the score indicates the number of destinations for which the new route would improve transfers passing through node X by more than the threshold.

The score threshold, Ts, may be any desired value from zero up to any desired value such as, for example, a throughput improvement of twenty-five percent, wherein the throughput of the new route less the throughput of the existing route divided by the throughput of the existing route is greater than twenty-five percent, or:

(Throughput New−Throughput Old)/Throughput Old>0.25.

Furthermore, each time the new route is determined to be better than the existing route by more than the score threshold, Ts, a score will be incremented. Thus, after every route passing through node X has been tested for one or more desired characteristics, the score will be equal to the number of routes that are improved by using the X to Y route over the previously used route. The score may then be compared to the total number of routes passing through the node being tested (i.e., node X) by dividing the score by the total routes passing through that node. If the percentage of improved routes is greater than the add threshold, Ta, the new link X to Y will qualify as the optimum route for one or more characteristics and will, therefore, be utilized to transfer data requiring optimization of those characteristics. If the score divided by the total number of paths is less than the add threshold, Ta, the new link X to Y will be discarded.

Similarly, periodically, the link layer of node X may also evaluate all of its existing links. If the benefit to X of a link, L that connects to a node W is below a “drop” threshold, Td, and the benefit of link L to W is also below Td, then that link may be dropped. Route testing for existing links is performed in the same way as route testing for new routes, which has been described above in connection with the node X to node Y link and the comparison of a resulting score to add threshold Ta. Again, because each node exchanges its routing state with its directly connected neighbors, each node is also able to perform routing calculations from the perspective of the neighbors. To prevent a large number of links from being accumulated at a node and to prevent links that are near the add threshold from being added and dropped repeatedly, the drop threshold, Td, may be set to a lower value than Ta. In that way, a hysteresis is built into the present invention such that there is a high standard for adding a link and a lesser standard for dropping a link.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. An overlay on a wide area network, wherein the wide area network includes at least one backbone network, comprising a processor coupled to the backbone network, wherein said processor contains instructions which, when executed by said processor, cause said processor to optimize real time performance of data delivery from the processor to another processor on the wide area network.

2. A method of selecting an optimum route from a first processor to a second processor in a wide area network and of selecting an optimum route from a third processor to a fourth processor in the wide area network, comprising:
selecting a first characteristic to be optimized in the route between the first processor and the second processor;
measuring the characteristic on a first route coupling the first processor to the second processor;
measuring the characteristic on a second route coupling the first processor to the second processor;
selecting from the first route and the second route, the route having the best performance based on the first characteristic;
selecting a second characteristic to be optimized in the route between the third processor and the fourth processor;
measuring the characteristic on a third route coupling the third processor to the fourth processor;
measuring the characteristic on a fourth route coupling the third processor to the fourth processor; and
selecting from the third route and the fourth route, the route having the best performance based on the second characteristic.

3. A method of optimizing at least two routes in a wide area network, comprising
optimizing a first route based on a first characteristic; and
optimizing a second route based on a second characteristic.

4. The method of claim 3, wherein the characteristic is a performance criterion.

5. The method of claim 4, wherein the performance criterion is throughput and throughput is to be maximized.

6. The method of claim 4, wherein the performance criterion is latency and latency is to be minimized.

7. The method of claim 4, wherein the performance criterion is variation in throughput and variation in throughput is to be minimized.

8. The method of claim 4, wherein the performance criterion is variation in latency and variation in latency is to be minimized.

9. The method of claim 4, wherein the performance criterion is cost and cost is to be minimized.

10. The method of claim 4, wherein the performance criterion is network hop count and network hop count is to be minimized.

11. The method of claim 4, wherein the performance criterion is processor hop count and processor hop count is to be minimized.

12. The method of claim 3, wherein the characteristic is a combination of at least two performance criteria.

13. A method for coupling nodes of an overlay network on a wide area network, wherein the wide area network includes a plurality of component networks, comprising:
coupling a node to a first local area network near a first peering point of the first component network;
coupling a node to a second local area network near a first peering point of the second component network;
coupling a node to the first local area network near a second peering point of the first component network; and
coupling a node to a stub network.

14. A method for finding a route having optimum throughput on a computer network, comprising:
determining a size of a message sent along the route;
determining a delay time required to pass a small amount of data along the route;
determining a duration of time required to pass the message along the route; and
calculating throughput of the route from message size, delay time, and duration.

15. The method of claim 14, wherein determining a delay time, further comprises:
measuring a delay time for a plurality of data passes along the route;
calculating a mean absolute underestimated error for the plurality of delay time measurements; and
selecting a delay time that minimizes the mean absolute underestimated error.

16. The method of claim 14, wherein determining throughput, further comprises:
measuring a throughput for a plurality of data passes along the route; and
averaging the plurality of measured throughputs while weighting recent measurements more than earlier measurements.

17. A method of selecting an optimum route from a first processor to a second processor in a wide area network, comprising:
selecting a first characteristic to be optimized in the route between the first processor and the second processor;
measuring the characteristic on a first route coupling the first processor to the second processor;
measuring the characteristic on a second route coupling the first processor to the second processor;
selecting from the first route and the second route, the route having the best performance based on the first characteristic;
selecting a second characteristic to be optimized in the route between the first processor and the second processor;
measuring the characteristic on the first route coupling the first processor to the second processor;
measuring the characteristic on the second route coupling the first processor to the second processor; and
selecting from the first route and the second route, the route having the best performance based on the second characteristic.
